(19) United States
(12) Patent Application Publication
(10) Pub. No.: US 2002/0162415 A1
(43) Pub. Date: Nov. 7, 2002

(54) Locking device

(76) Inventor: Markus Gross, Raisting (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/130,658

(22) PCT Filed: Dec. 1, 2000
(86) PCT No.: PCT/DE00/04311

(30) Foreign Application Priority Data
Dec. 1, 1999 (DE) 199 57 749.8

(51) Int. Cl. G05G 5/06

(52) U.S. Cl. 74/530

(57) ABSTRACT

The invention relates to a locking device, comprising a drive gear (8) that can be rotated around its drive axis (9); a driven gear (10) that can be rotated around its driven axis (11), whereby the perimeter of the driven gear (10) can be drive-connected to the perimeter of the drive gear (8); a drive surface (17) that is drive-connected in a fixed manner to the drive gear (8) and whose displacement path relative to the drive gear (8) can be translated into a rotation thereof (8). The invention aims at providing a simply constructed locking device enabling reliable, low-noise locking. This is achieved in that a lifting device (12, 20) is provided for the driven gear (10) by means of which the driven gear (10) and the drive surface (17) can be disengaged.

The invention relates to a locking device according to the preamble of claim 1, comprising a drive gear that can be rotated about its drive axle; a driven gear that can be rotated about its driven axle, wherein the periphery of the driven gear is capable to be brought into a drive connection with the periphery of the drive gear; a drive surface, which is in a fixed drive connection with the drive gear and whose relative displacement travel in relation to the drive gear can be converted into a rotation of the same. The invention further relates to uses of the locking device, and to a parking brake for a vehicle according to the preamble of claim 14 or 15, comprising a brake actuating lever, which is arranged in an articulated manner on a lever holder; a coupling unit which tensions a brake cable when the brake actuating lever is displaced; a locking unit which holds the brake actuating lever releasably in a locking position on the lever holder.

WO-A-98 57 832 describes a locking device for setting the cable mechanism of a brake cable of a parking brake, in which a pulling element provided with a toothed surface is prestressed, by the prestressing of a spring, counter to the loading on the brake cable and the brake actuating elements coupled to the latter, it being possible for the toothed surface to be locked by means of toothing facing the latter on a clamping piece in the manner of a latching block. The clamping piece has a wedge-shaped head, which is supported against a likewise wedge-shaped wedge guide belonging to a clamping housing and, on the basis of ends which belong to a guide pin, project laterally from the head and force said guide pin to make a positive movement along two likewise wedge-shaped ramps of the blocking housing, is lifted when the clamping piece is displaced axially, so that the clamping piece at the same time executes a movement leading away from the toothing. On account of a blocking spring, the clamping piece is prestressed in the engaged position in order to produce the latching block, so that when the parking brake is actuated, the brake cable mechanism is tensioned via this latching block. When the parking brake is released an angular attachment on the clamping piece, against which the blocking spring is supported, strikes against a stop, as a result of which the clamping piece is displaced axially, tensioning the blocking spring and, because of the guidance, is also disengaged from the pulling element, as a result of which the latching block is lifted. The stop is actuated when the parking brake is released, so that it is released each time the parking brake is released. When the brake actuating lever of the parking brake is lifted, the brake cable, in its position assumed on the basis of the position of the pulling element according to the prestressing of the spring and in which the brake cable is not to exhibit any sag, is tensioned in order to actuate the braking elements by the blocking spring displacing the clamping piece again in the direction of an effective latching block of the toothing as its attachment is removed from the stop. Because of the coaxial design of the blocking spring and the spring for adjusting the brake cable, the known locking device is susceptible to slipping movements of the pull rod. Furthermore, because of the type of toothing, the locking permits only a limited number of settings of the latching block; it would be desirable to provide a greater number of more finely settable latching positions. Furthermore, the toothing must be designed as sawblade toothing, so that a considerable latching noise is perceptible when a relative movement of the two parts occurs.

Various locking devices are known from practice, particularly in the case of parking brakes, in order on the one hand to fix the brake actuating lever to the lever holder and, on the other hand, in order to provide a coupling unit for a brake cable, which tensions the brake cable when the brake actuating lever is displaced and otherwise permits automatic cable adjustment on the basis of a spring force. In this case, in order to fix the parts that can move relative to one another, elements that latch into toothing under the prestress of a spring are generally provided, the latching noise being found to be extremely annoying. When coupling a cable adjustment for a parking brake, this is therefore often banned from the region of the brake actuating lever, although it would be easily accessible there for repairs. In the case of locking means for the brake actuating lever, complicated constructions for the pawl are chosen in order to permit the pawls responsible for the development of noise to latch quietly under low spring forces.

WO-A-98 22 318 describes a parking brake in which a brake actuating lever is arranged such that it can pivot on a lever holder fixed to the bodywork, the brake actuating lever having a toothed section which is in engagement with a peripherally toothed gear which transmits the displacement movement of the brake actuating lever to a toothed pulling element of a brake cable mechanism. The brake cable mechanism and the brake actuating lever are therefore indirectly continuously operatively connected, so that automatic adjustment of the cable mechanism is not possible.

It is the object of the invention to provide a locking device according to the preamble of claim 1 and a parking brake according to the preamble of claim 14 or 15 in which reliable locking with a simple design is possible both reliably and with low noise.

For the locking device, respectively the parking brake, mentioned at the beginning, this object is achieved by the characterizing features of claim 1, in that a lifting arrangement for the driven gear is provided, with which the driven gear and the drive surface can be disengaged and, respectively, by the characterizing features of claim 14 and of claim 15 in that the coupling unit has a locking device as claimed in one of claims 1 to 11, the drive surface being coupled to the brake cable, while the drive axle of the drive gear is coupled to the brake actuating lever, and, respectively, in that the locking unit has a locking device as claimed in one of claims 1 to 11, the drive surface being arranged on the lever holder, while the drive axle of the drive gear is coupled to the brake actuating lever.

The locking device according to the invention has a drive gear whose periphery can be brought into engagement with a driven gear in order to produce a drive connection, the driven axle of the driven gear preferably being designed such that it can be displaced in a fixed radius toward and along said driven gear about the drive axle of the drive gear, so that the peripheral engagement of drive gear and driven gear is always ensured. In addition, the periphery of the drive gear has a drive connection to a drive surface, it being possible for the relative displacement travel between the two aforementioned parts to be converted into a rotation of the drive gear about its drive axle. If the driven gear is rotationally connected to the drive gear, the drive gear rotates in one direction while the driven gear rotates in the opposite direction. The driven axle of the driven gear in the locking position of the locking device is of the same distance from the drive surface as the drive axle of the drive gear, so that there is likewise a—theoretical—drive connection between the drive surface and the driven gear. However, since this would rotate in the direction opposite to the drive gear, the peripheral engagement of the driven gear with the drive surface blocks a displacement movement of the same. In this case, the driven gear is prestressed in the direction of the drive surface under its inherent weight and also preferably under the prestress of a spring designed for this purpose, so that the prestress of the driven gear defines a holding force for the locking action. In order to unlock the locking device, according to the invention a lifting arrangement for the driven gear is provided, with which driven gear and drive surface can be disengaged, it being necessary for the lifting arrangement to lift at least the inherent weight of the driven gear and, if necessary, also the prestressing on the basis of a spring. The lifting arrangement can be designed both as a stop which, in the case of a displaceable locking device, lifts the driven gear as a function of the position of the locking device or permits it to engage with the drive surface; it is alternatively possible to provide for this purpose a means which can be released or actuated manually, such as a spring-prestressed grip, release knob or the like.

The locking device according to the invention has, in particular, the advantage that when the drive surface is displaced relative to the drive gear and the driven gear in the direction of the driven gear, the displacement movement is possible, in spite of the blocking driven gear, if the lifting arrangement for the latter is designed in such a way that slight lifting is permitted. If a strong spring is provided, this type of slip can also be prevented. When the drive surface is displaced in the direction of the drive gear, on the other hand, the drive gear, whose drive axle is arranged at a fixed distance from the drive surface, holds the drive surface firmly, since the forces transmitted from the driven gear to the drive gear exactly counteract the displacement of the drive surface and therefore effect the locking of the locking device. Accordingly, it is expedient to arrange the driven gear to face the tightening direction.

The drive gear, the driven gear and the drive surface preferably each have toothing which is formed over at least part of the periphery of the gears, so that the transmission of the respective displacement movements to the meshing constituents is made possible with better grip and more reliable, in particular slip-free, transmission. As opposed to the likewise possibly flat peripheral surfaces of the drive surface or of the drive gear and of the driven gear or of the peripheral surfaces profiled in another way, which are likewise possible, in particular in the case of surfaces being implemented from rubber or from plastic or from metal, a drive connection is reliably produced, even if there is little play, in particular between the driven gear and the drive surface, when these come into mutual engagement. In this case, the rolling of the gears on one another, on the one hand, and on the drive surface, on the other hand, take place with little development of noise, since the prestressing of the spring for displacing the driven gear in the direction of the drive surface does not have to produce any high forces, since the locking action is primarily carried out by the driven gear engaging with the drive gear and, in addition, the rotational/rolling movement of the driven gear produces a quieter rolling movement than a latching pawl. Furthermore, as a result of holding the drive surface in the immediate vicinity of the driven gear encountering it, because of the engagement with the drive gear, effective attenuation of the vibrations which occur during the resetting of the driven gear is produced, so that the development of noise is extremely low. It is reduced still further when at least one of the surfaces or peripheral surfaces involved in the engagement is formed from a plastic.

In order to unlock the locking device, a release device is expediently provided, which releases the driven gear from the engagement with the drive surface, for example when free movement of the drive surface relative to the drive gear is desired. For instance, when the locking device is installed in a parking brake as a cable adjusting device, this is the case when the parking brake is released and, on account of a tension spring that tensions a pulling element having the drive surface, is intended to adjust counter to the load from the braking element that acts on the brake cable in such a way that sagging of the brake cable is prevented. In this case, the tension spring is designed in such a way that it reliably prevents the brake cable sagging, without moving the braking cylinders themselves in the direction of the wheels to be braked. The play in the brake cable, for example on the basis of wear on the brake linings or temperature-induced lengthening or shrinkage of the brake cable, is itself low, so that as a rule the adjustment can barely be measured from case to case, but over a certain time period makes up noticeable displacement travel distances of the drive surface. The locking device according to the invention permits particularly fine adjustment, since the graduation of the drive gear and of the driven gear and the toothing on the drive surface permits a latching accuracy that is substantially more precise and has a plurality of positions. By means of appropriate limits, it is possible to limit the maximum rotational angle of the drive gear, for example.

According to an advantageous development of the locking device according to the invention, the drive surface has a curved cam shape, preferably that of a disk which, in the case of peripheral toothing, meshes with the drive gear and/or with the driven gear. A drive surface with such a curved design can advantageously be arranged on one of the moving or fixed parts of a parking brake device, for example by means of mounting, by riveting or the like, while axial movements in the region of a parking brake are always difficult to integrate. In particular, if a curved cam shape is provided, the brake cable can be arranged eccentrically on the disk, which can be rotated in a defined manner on the cam shape, so that a force transmission ratio can be set by means of the distance selected.

According to another preferred development of the locking device according to the invention, the drive surface has a linear surface which, for example, is coupled to a pulling element at the end of the brake cable or an extension of the same and which is pulled axially under spring prestress counter to the action of the brake cable. In the case of such a linear arrangement, the prestressing force can be implemented particularly beneficially as a compression spring, which is supported on one side against the pulling element and on the other side against a part which is fixed relative to the axis of the drive gear, as a result of which a particularly simple change of the spring force required for the tensile force for adjusting a brake cable is made possible as a function of the model. Furthermore, it is possible to secure a drive surface formed with a linear surface by means of a second locking means, which is formed on a further drive surface parallel to the first-named drive surface and in the same pulling element, said further drive surface expediently being formed on the rear, that is to say the surface facing away from the first drive gear. Alternatively, it is also possible to equip the same drive surface of the pulling element with two further drive or driven gears, which would then be capable of being displaced parallel to the first pair. In the case of a mirror-image arrangement, the locking device would be locked in both directions. If the drive surface were to be arranged on the rear of the first drive surface, the function of the locking device would be designed in duplicate in the case of a mirror-image arrangement, while in the case of an arrangement rotated through 180°, the displacement would again be inhibited in both directions.

It is possible to arrange the drive gear to be fixed to a part via its drive axle, for example, while a guide permits the displacement of the drive surface relative to the drive gear rotatably mounted in a fixed location. Alternatively, however, it is also possible to mount the drive axle of the drive gear in a housing or a holder which itself is in turn mounted on a further part such that it can be rotated or pivoted, in order in particular to compensate for a pivoting movement of the further part by means of pivoting the housing, in order that the outgoing angle of the drive surface remains constant or is independent of the pivoting angle of the further part.

The locking device according to the invention may advantageously be used as an automatic cable adjusting device for the brake cable or as a locking device for the brake actuating lever of a parking brake. In both advantageous uses, use is beneficially made of the possibility of locking the locking device, in the case of an automatic cable adjusting device it being ensured, for example by means of a stop or the like, that the driven gear is lifted when the parking brake is in the released position, so that adjustment of the brake cable on the basis of displacing the drive surface in both directions relative to the drive gear is possible.

A first parking brake according to the invention provides for its coupling unit to be designed as a locking device of the above-described type, the drive surface being coupled to the brake cable, while the drive axle of the drive gear is coupled to the brake actuating lever, if necessary via intermediate levers.

A second parking brake according to the invention provides for the locking unit to be designed as a previously described locking device, the drive surface being arranged on the lever holder, in particular in the form of at least partial peripheral toothing, while the drive axle of the drive gear is coupled to the brake actuating lever.

A release device, which at the same time can incorporate the lifting arrangement of the locking device, permits the locking device to be unlocked by means of disengaging the driven gear from the drive surface, this disengagement requiring, for example, the overcoming of a spring force with which the driven gear or the release device is secured.

The parking brake may be both a hand-operated parking brake and a foot-operated parking brake.

Further advantages and features of the invention emerge from the following description and from the dependent claims.

The invention will be explained in more detail below with reference to preferred exemplary embodiments and referring to the enclosed appended drawings.

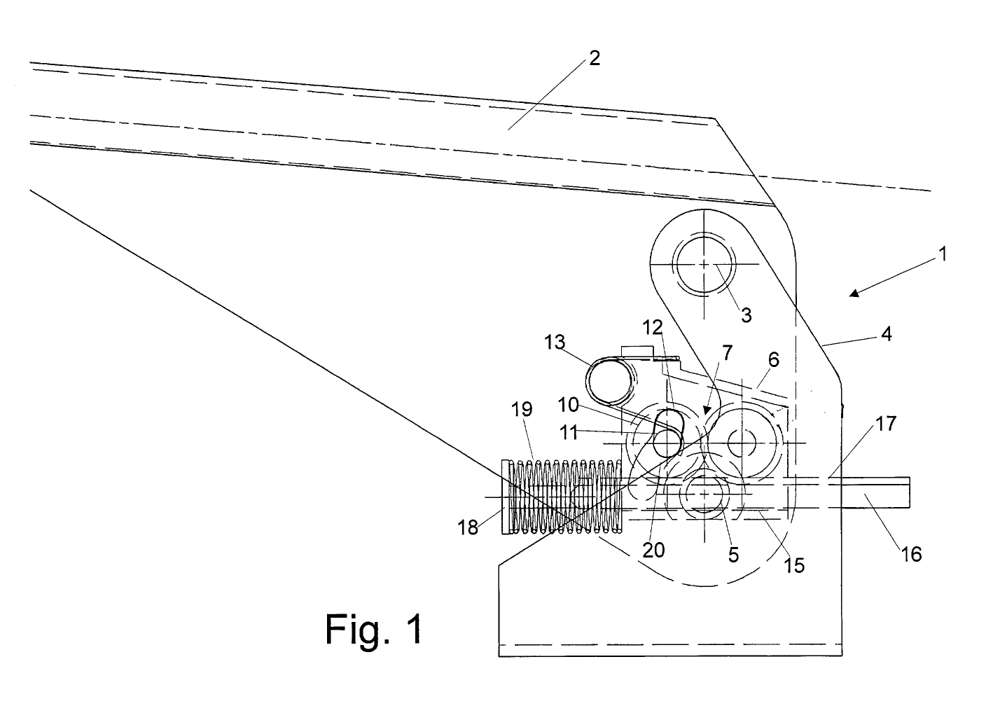

FIG. 1 shows a first exemplary embodiment of a locking device according to the invention, which is arranged in a hand-operated parking brake.

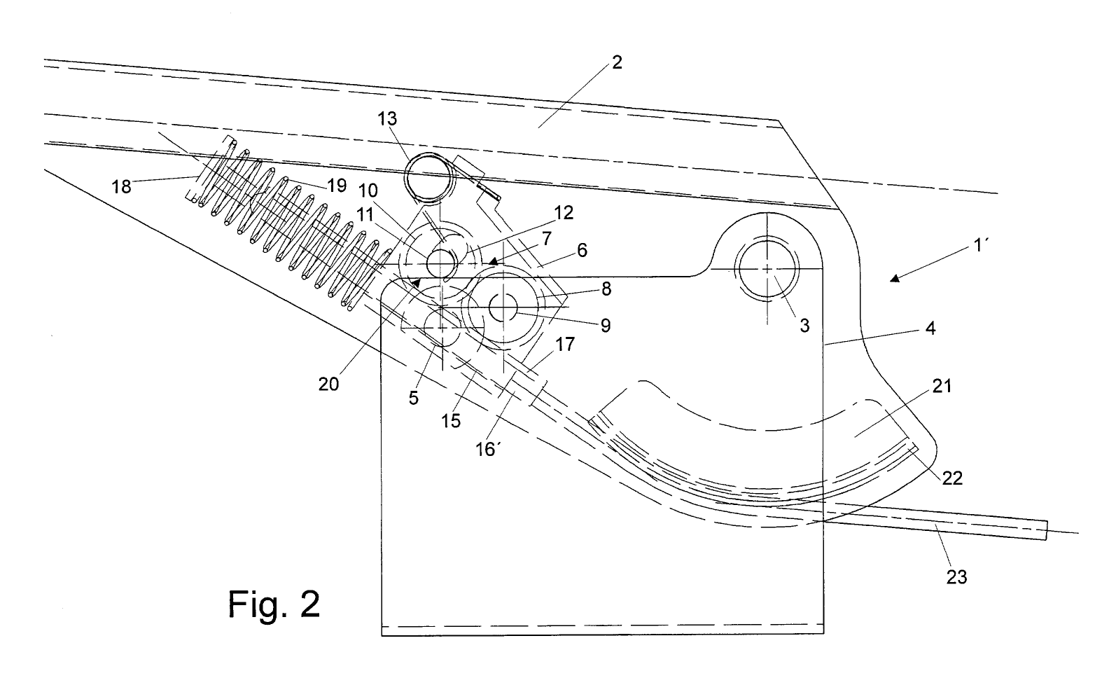

FIG. 2 shows a second exemplary embodiment of a locking device according to the invention, which is arranged in a hand-operated parking brake.

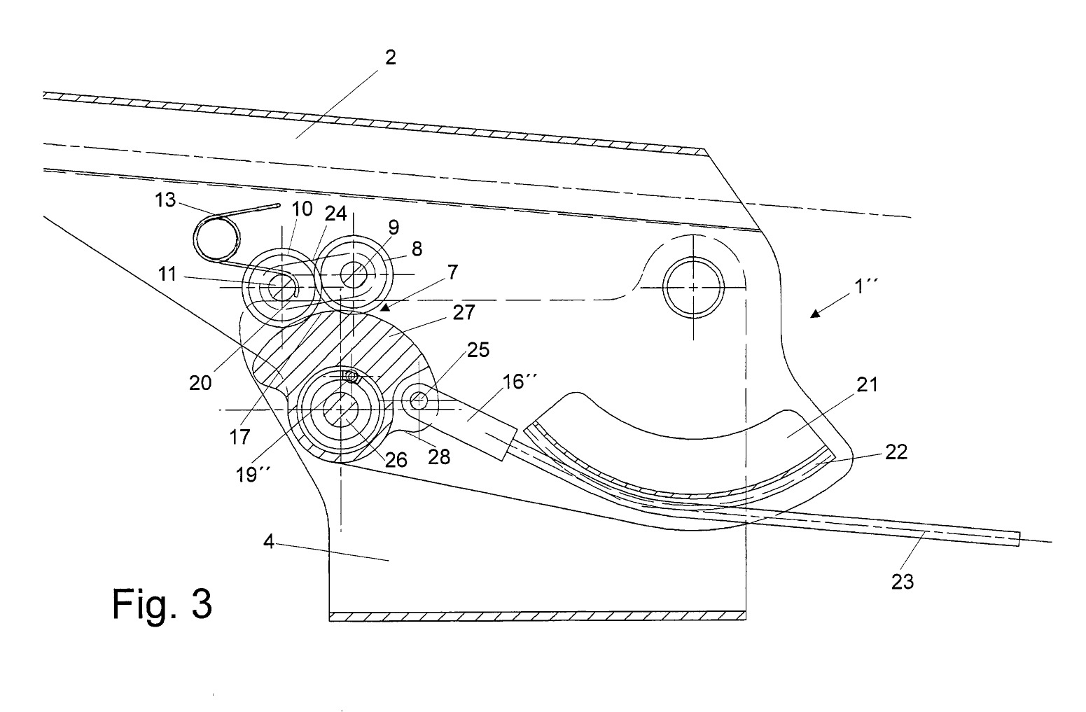

FIG. 3 shows a third exemplary embodiment of a locking device according to the invention, which is arranged in a hand-operated parking brake.

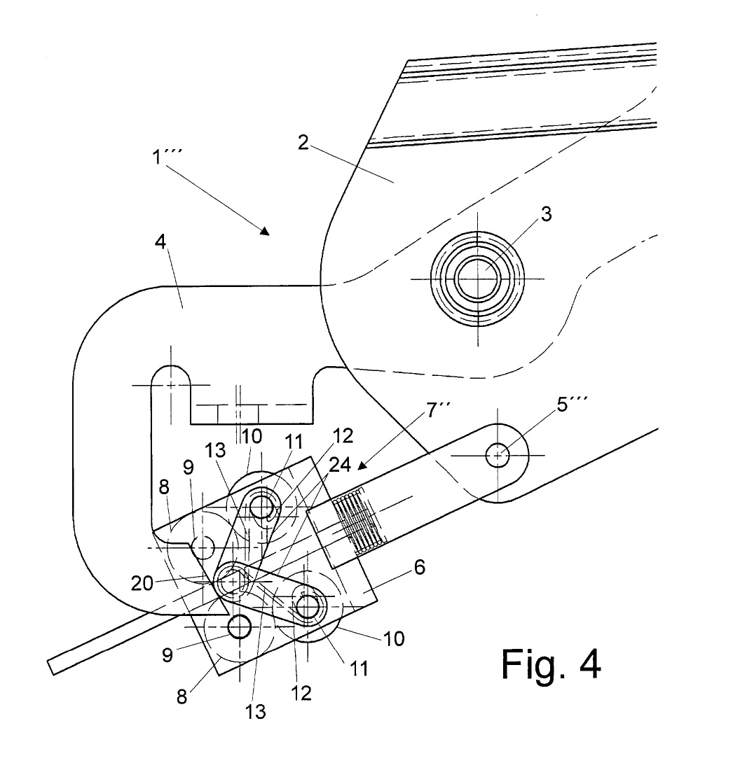

FIG. 4 shows a fourth exemplary embodiment of a locking device according to the invention, which is arranged in a hand-operated parking brake.

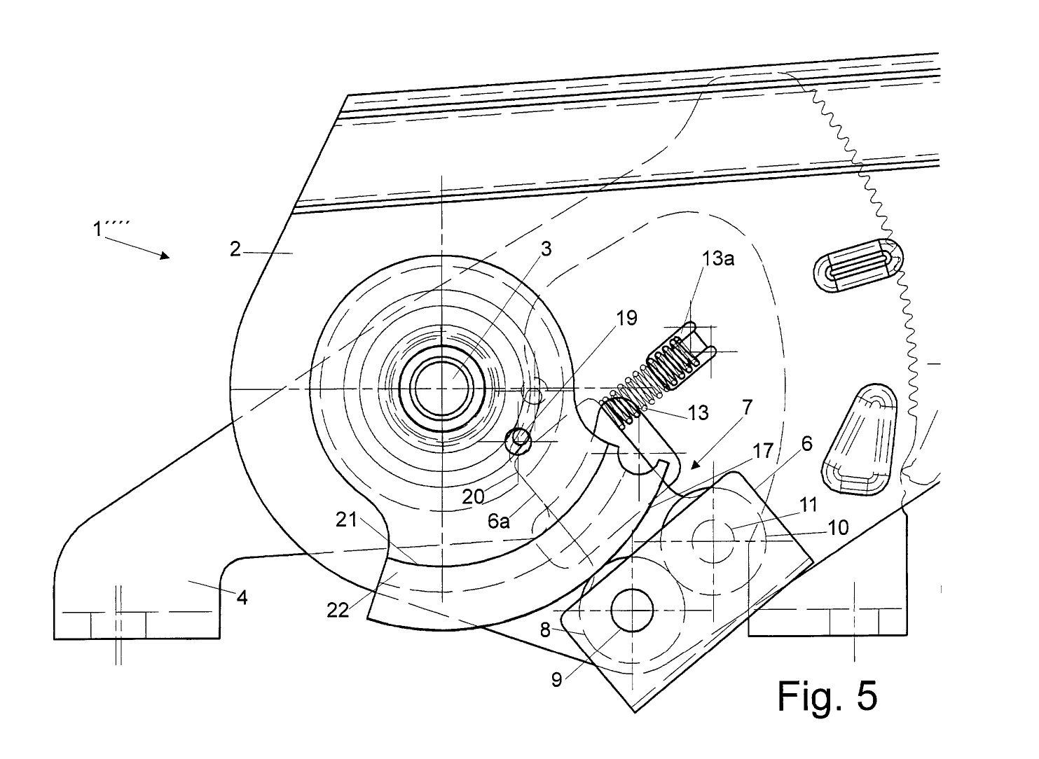

FIG. 5 shows a fifth exemplary embodiment of a locking device according to the invention, which is arranged in a hand-operated parking brake.

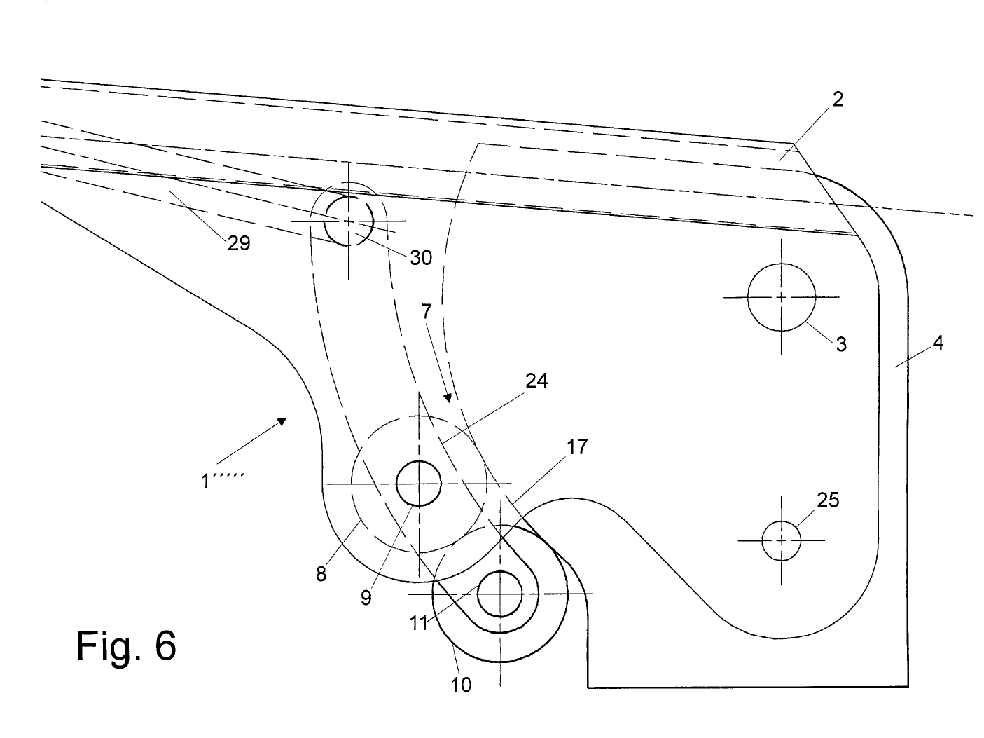

FIG. 6 shows a sixth exemplary embodiment of a locking device according to the invention, which is arranged in a hand-operated parking brake.

FIG. 1 shows a side view of a hand-operated parking brake 1 which has not been tightened completely and in which a brake actuating lever 2 is arranged on a lever holder 4 by means of an attachment 3 such that it can be pivoted. The brake actuating lever 2 can be pivoted by being raised and lowered with respect to the lever holder 4, a pawl (not illustrated) arranged on the brake actuating lever 2 locking the brake actuating lever 2 against toothing (not illustrated) on a periphery of the lever holder 4, until the locking action is released again, for example by means of actuation of a spring-prestressed release knob in the grip area of the brake actuating lever 2 and corresponding lifting of the pawl of the toothing.

Rotatably mounted on the brake actuating lever 2, at an attachment 5 spaced apart from the attachment 3, is a housing 6 having a locking device designated by reference symbol 7, which is intended for the automatic cable adjustment when the brake actuating lever 2 is released and for the actuation of the brake linings when the brake actuating lever 2 is tightened.

In the housing 6, which can be pivoted about the attachment 5 relative to the brake actuating lever 2, a completely peripherally toothed drive gear 8 is mounted about its drive axle 9 and meshes with a driven gear 10, which is mounted via its driven axle 11 in a slot 12 in the housing 6, said slot being formed in a curve in a radius about the drive axle 9. The driven axle 11 is prestressed in the direction of the downward pointing end of the slot 12 by a leg spring 13, whose one end is supported against the housing 6 and whose other end is supported against the driven axle 11. Provided so as to slide on a guide surface 15 of the housing 6 is a pulling element 16 which is of flat form on its underside, passes axially through the housing 6 in its extent and has a section provided with a toothed drive surface on its surface facing away from the guide surface 15. At its end, the pulling element 16 has a stop 18, which projects beyond the housing 6 at the top and bottom and therefore prevents the pulling element tearing out of the housing 6 and against which there is supported a tension spring 19 which, in the present case, is formed as a compression spring, at its other end is supported against a corresponding surface of the housing 6. The tension spring 19 prestresses the pulling element 16 and the parts fastened to the latter in the direction of the axle of the pulling element 16 which, in the illustration according to FIG. 1, coincides with the direction of travel x of the vehicle in which the handbrake is mounted. At the end of the pulling element that faces away from the tension spring 19, a cable mechanism (not illustrated) is coupled, leading to the braking elements on the wheels of the vehicle, which braking elements are intended to be tensioned in order to provide a braking connection when the brake actuating lever is tightened.

The housing 6 is formed as a holder, which surrounds the drive gear and the driven gear on both sides and also the guide surface 15 that forms the bottom of the housing 6, it being possible for the housing 6 to be produced cost-effectively as a sheet-metal part.

20 designates a stop which is formed on the lever holder 4 and against which one end of the driven axle 11 strikes when the brake actuating lever 2 is released. The driven axle 11 is then displaced in the slot 12 in the direction of its upper end, as a result of which the peripheral toothing of the driven gear 10 is disengaged from the drive surface 17. The stop 20 ensures that when the brake actuating lever 2 is released, the hand-operated parking brake 1 can adjust the brake cable coupled to the pulling element 16 on the basis of the force of the tension spring 19.

It should be noted that it is in principle possible to adjust the pulling element 16 in the direction of the driven gear, but not in the direction of the drive gear, when the brake actuating lever 2 is tightened.

The hand-operated parking brake 1′ according to FIG. 2 uses in principle the same locking device 7 as the hand-operated parking brake 1 from FIG. 1, for which reason the same reference symbols designate the same parts and, if appropriate, are identified by a prime to distinguish them.

As distinct from the exemplary embodiment according to FIG. 1, a cable pulley 21 is formed around the lever holder 4 at a predetermined radius around the attachment 3 of the brake actuating lever 2 and has a groove or channel 22 in which the brake cable 23, which is connected to the pulling element 16′, leads laterally. In addition, the housing 6 of the hand-operated parking brake 1′ is attached by an attachment 5 to the brake actuating lever, it being ensured that the brake cable 23 always leaves the brake actuating lever 2 tangentially on account of the configuration and the curvature of the cable pulley 21.

Because of the arrangement of the housing 6, the stop 20 on the lever holder 4 is arranged somewhat differently in the area further forward of the brake actuating lever, but it is unchanged in terms of its function.

FIG. 3 shows a further exemplary embodiment of a hand-operated parking brake 1″, in which the same parts as in the two preceding exemplary embodiments are designated by the same reference symbols, if appropriate supplemented by a double prime.

As distinct from the preceding exemplary embodiments, the drive gear 8 and the driven gear 10 are not accommodated in a housing; instead, the drive axle 9 of the drive gear 8 is arranged directly on the brake actuating lever 2, and the driven axle 11 of the driven gear 10 is attached to the drive axle 9 via a lever 24, the driven axle 11 again being prestressed by the spring 13 in the direction of a drive surface 17. The driven axle 11 can therefore be displaced in the radius about the drive axle 9 counter to the prestress of the spring 13.

As distinct from the preceding exemplary embodiments, the drive surface 17 is provided on the periphery of a gear 27 that is attached to the brake actuating lever 2 via an attachment 26, the pulling element 16″ being fixed to the gear 27 by means of a joint 25 acting as a cable attachment. The gear 27 is prestressed in the direction of the tightening of the brake cable 23 by means of a tension spring 19″ and it is additionally possible to provide a stop on the brake actuating lever 2, against which the projecting nose-like protrusions 28 can strike, in order to provide a maximum limitation for the relief of the tension on the brake cable 23 beyond that predefined by the attachment 26. The spring 19, which prestresses the gear 27 and the brake actuating lever 2 in opposite directions, is formed as a torsion spring and defines the adjusting force for the brake cable 23 when the brake actuating lever 2 is released.

When the brake actuating lever 2 is released, the stop 20 tensions the spring 13, by lifting the driven gear 10 off the drive surface 17 of the gear 27 via the driven axle 11. Then, only the peripheral toothing on the drive gear 8 and gear 27 are still engaged, so that free mutual rotation is provided. As soon as the brake actuating lever 2 is raised, the driven gear 10 is lowered and comes into engagement with the drive surface 17, as a result of which effective locking of the locking device 7 of the hand-operated parking brake 1″ occurs.

The further exemplary embodiment according to FIG. 4 shows a detail of a hand-operated parking brake 1′″, in which the same reference symbols as in the preceding exemplary embodiments designate the same parts.

As distinct from the preceding exemplary embodiments, the housing 6 with the locking device 7′″ is arranged such that it can pivot on the brake actuating lever 2 via a projection provided on the latter, on an attachment 5′″, the locking device 7′″ differing substantially from the arrangement according to FIG. 1 in that, firstly, the pulling element 16 is equipped with a drive surface 17 on both sides and therefore cannot be displaced along a guide surface of the housing 6, both drive surfaces 17 being engaged in substantially mirror-image fashion with the drive gear 8 and driven gear 10. The springs 13 prestress the driven gears in the direction of the drive surface 17 via legs engaging on both ends of both driven axles 11, a stop 20 on the lever holder 4, engaging around the housing 6 at the rear, acting on two levers 24 which interact with the driven axles 11 in order to displace the driven axles counter to the prestress of the springs 13 out of their position in which they are engaged with the drive surfaces 17. It has to be understood that the legs of the spring 13 acting on the driven axles 11 can also be legs of the same spring. When the brake actuating lever 2 is tightened, the levers 24 are lifted out of engagement with the stop 20, and the pulling element 16 is correspondingly locked in its position.

The further exemplary embodiment according to FIG. 5 shows a detail of a hand-operated parking brake 1″″, in which the same reference symbols as in the preceding exemplary embodiments designate the same parts.

As distinct from the preceding exemplary embodiments, the drive surface 17 is formed on at least one projecting part of the cable pulley 21 which forms a circular segment, guides the brake cable 23 (not illustrated) and for which an anchoring means is provided at the front end of the guide groove 22. The cable pulley 21 is arranged such that it can pivot on the lever holder 4 with the same attachment 3 with which the brake actuating lever 2 is also attached to said lever holder 4. A tension spring 19 designed as a spiral spring 19 prestresses the lever holder 2 and the cable pulley 21—comparable with the hand-operated parking brake 1″ from FIG. 3—in opposite directions, so that when the brake actuating lever 2 is released, because of the force of the tension spring 19, the cable pulley 21 is pivoted relative to the brake cable 23 in order to tension the latter.

The drive gear 8 and driven gear 10 accommodated in a housing 6 are connected in an articulated manner to the brake actuating lever 2 via the drive axle 9, a projection 6a on the housing 6 striking against a stop 20 on the lever holder when the parking brake 1″″ is released, in such a way that the driven gear 10 comes out of engagement with the drive surface 17 of the cable pulley 21. When the hand-operated parking brake 1″″ is tightened, the brake actuating lever 2 is moved away from the stop 20, and a helical spring 13 which is pivotably mounted on the brake actuating lever 2 and is supported against the projection 6a and against a part 13a mounted on the brake actuating lever 2 prestresses the housing 6, and therefore the driven axle 11 mounted in the latter and having the driven gear 10, against the drive surface 17, so that the latter is locked with respect to the brake actuating lever 2, and a tightening force is transmitted to the brake cable 23. It has to be understood that other means acting in the same way are possible in order to raise and lower the driven gear 10 for the purpose of engaging or disengaging the driven gear 10 and the drive surface 11.

The further exemplary embodiment according to FIG. 6 shows a detail of a further hand-operated parking brake 1′″″, in which the same reference symbols as in the preceding exemplary embodiments designate the same parts. Likewise, the locking device 7 here finds a different use from that in the preceding exemplary embodiments, it being possible for the cable attachment designated by 25 in FIG. 6 also to be implemented by the locking device of the exemplary embodiments according to FIGS. 1 to 5.

In the hand-operated parking brake 1′″″ according to FIG. 6, the locking device 7 is provided in order to fix the brake actuating lever 2 in its tightened position with respect to the lever holder 4. For this purpose, the drive gear 8 with its drive axle 9 is fixed to the brake actuating lever 2, and the driven gear 10 is arranged on the inner side of a double lever 24 formed in the manner of a rocker, whose other end, placed on the other side of the drive axle 9, is connected via a link 30 to a pressure linkage designated by 29 and acted on by a spring (not illustrated), in such a way that when a release knob (not illustrated) is actuated counter to the prestress of the spring in accordance with the relationships between the lever arms of the double lever 24, the driven gear 10 is lifted off the drive surface 17, the spring of the pressure linkage 29 at the same time effecting the prestressing of the driven gear 10 with respect to the drive surface 17. The tilting axis is defined by the drive axle 9 of the drive gear 8.

On account of the slip arising from a relative displacement of the drive surface 17 in the direction of the driven gear 10, the brake actuating lever 2 can also be raised and locked securely without the release knob being actuated; following the completion of the lifting movement, the brake actuating lever 2 can be released only by the release knob being actuated. The lifting operation is carried out with extremely low noise, since because of the slip and the rotational movement of the drive gear 8, the chattering of the locking devices known from the prior art and also indicated in the drawing, for example in FIG. 5 is prevented. Furthermore, the number of possible positions is significantly higher than in the prior art, because of the graduation of the drive gear 8 and of the driven gear 10, which preferably have an identical periphery, so that a large number of tightening positions, going as far as continuous fixing of the brake actuating lever 2, in any case a number of tightening positions going beyond the normal single-digit number of latching teeth is possible.

The cable attachment 25 in the present case has been provided directly on the brake actuating lever 2. It has to be understood that the fixing to the double lever 24 and the formation of a cable pulley in a manner similar to the above-described exemplary embodiments is alternatively also possible.

The locking device 7 according to the invention has been described above using a number of exemplary embodiments, and also in different applications. It goes without saying that these can also be used in devices other than in hand-operated parking brakes, for example in foot-operated parking brakes or in quite different devices.

1. A locking device, comprising
a drive gear (8) that can be rotated about its drive axle (9);
a driven gear (10) that can be rotated about its driven axle (11), wherein the periphery of the driven gear (10) is capable to be brought into a drive connection with the periphery of the drive gear (8);
a drive surface (17), which is in a fixed drive connection with the drive gear (8) and whose relative displacement travel in relation to the drive gear (8) can be converted into a rotation of the same (8), characterized in that a lifting arrangement (12, 20; 24, 20; 6a, 20) for the driven gear (10) is provided, with which the driven gear (10) and the drive surface (17) can be disengaged.

2. The locking device as claimed in claim 1, characterized in that in one direction of the displacement travel of drive surface (17) and drive gear (8) relative to each other, the driven gear (10) permits a displacement, while in the other direction the driven gear (10) blocks the drive surface (17).

3. The locking device as claimed in claim 1 or 2, characterized in that a spring (13) is provided, which prestresses the driven gear (10) in the direction of the drive surface (17).

4. The locking device as claimed in one of claims 1 to 3, characterized in that the drive axle (9) of the drive gear (8) assumes a fixed distance from the drive surface (17).

5. The locking device as claimed in one of claims 1 to 4, characterized in that the drive surface (17), the drive gear (8) and the driven gear (10) are formed with toothing.

6. The locking device as claimed in one of claims 1 to 5, characterized in that a release device (20) is provided in order to release the driven gear (10) from the engagement with the drive surface (17).

7. The locking device as claimed in one of claims 1 to 6, characterized in that the drive surface (17) has a curved cam shape (27).

8. The locking device as claimed in one of claims 1 to 6, characterized in that the drive surface (17) has a linear surface.

9. The locking device as claimed in claim 8, characterized in that parallel to the drive surface (17), a further drive surface (17) is provided, with which a further drive gear (8) that can be rotated about its drive axle (9) and a further driven gear (10) that can be rotated about its driven axle (11) define a further locking means.

10. The locking device as claimed in one of claims 1 to 9, characterized in that the drive surface (17) exerts a pulling force with a preset prestress (19) on a pull cable (23) that is coupled and to be pretensioned.

11. The locking device as claimed in one of claims 1 to 6, characterized in that the drive surface (17), drive gear (8) and driven gear (10) are accommodated in a housing (6) which is in turn mounted on the brake actuating lever (2), preferably such that it can pivot.

12. The use of the locking device as claimed in one of claims 1 to 11 as an automatic cable adjusting device for the brake cable (23) of a parking brake.

13. The use of the locking device as claimed in one of claims 1 to 11 as a locking device for the brake actuating lever (2) of a parking brake.

14. A parking brake for a vehicle, comprising
a brake actuating lever (2), which is arranged in an articulated manner on a lever holder (4);
a coupling unit (25), which tensions a brake cable (23) when the brake actuating lever (2) is displaced;
a locking unit, which holds the brake actuating lever (2) releasably in a locking position on the lever holder (4); characterized in
that the coupling unit has a locking device as claimed in one of claims 1 to 11, the drive surface (17) being coupled to the brake cable (23), while the drive axle (9) of the drive gear (8) is coupled to the brake actuating lever (2).

15. A parking brake for a vehicle, comprising
a brake actuating lever (2), which is arranged in an articulated manner on a lever holder (4);
a coupling unit (25), which tensions a brake cable (23) when the brake actuating lever (2) is displaced;
a locking unit, which holds the brake actuating lever (2) releasably in a locking position on the lever holder (4); characterized in
that the locking unit has a locking device as claimed in one of claims 1 to 11, the drive surface (17) being arranged on the lever holder (4), while the drive axle (9) of the drive gear (8) is coupled to the brake actuating lever (2).

16. The parking brake according to claim 15, characterized in that a release device (29) is provided in order to disengage the locking device (7) manually.

17. The parking brake as claimed in one of claims 14 to 16, characterized in that the brake actuating lever (2) is designed as a hand-operated parking brake formed with a hand grip.

18. The parking brake as claimed in one of claims 14 to 16, characterized in that the brake actuating lever (2) is designed as a foot-operated parking brake formed with a pedal.
